(19) United States
(12) Patent Application Publication
(10) Pub. No.: US 2016/0203624 A1
(43) Pub. Date: Jul. 14, 2016

(54) System and Method for Providing Combined Multi-Dimensional Map Views

(71) Applicant: Google Inc., Mountain View, CA (US)

(72) Inventor: John Carl Anderson, Santa Clara, SC (US)

(73) Assignee: Google Inc., Mountain View, CA (US)

(21) Appl. No.: 14/197,895

(22) Filed: Mar. 5, 2014

(51) Int. Cl. G06T 11/60; G06T 15/00

(52) U.S. Cl. CPC G06T 11/60; G06T 15/00

(57) ABSTRACT

In one aspect, a computer-implemented method for providing combined multi-dimensional map views may generally include receiving, by one or more computing devices, a first set of geospatial data associated with rendering a two-dimensional view of a first portion of a geographic area, receiving, by the one or more computing devices, a second set of geospatial data associated with rendering a three-dimensional view of a second portion of the geographic area and rendering, by the one or more computing devices, a combined map view of the geographic area based on the first and second sets of geospatial data. The combined map view may include a first discrete map area providing a two-dimensional map view of the first portion of the geographic area and a second discrete map area providing a three-dimensional map view of the second portion of the geographic area.

### FIELD

The present subject matter relates generally to systems and methods for a Geographic Information System (GIS) and, more particularly, to systems and methods for providing combined multi-dimensional map views within a GIS.

### BACKGROUND

Geographic Information System (GIS) clients capture, store, manage and display data elements according to geospatial coordinates. For example, mapping clients, such as Google Maps, render maps, satellite imagery and other data over a two-dimensional surface. Similarly, spinning-earth clients, such as Google Earth, render satellite imagery, terrain, vectors and other data over a three-dimensional geometry representing the Earth's surface. Thus, a user of Google Maps or Google Earth may navigate across the two-dimensional surface or three-dimensional geometry while data and images corresponding to geographical locations are presented to the user.

When using a GIS client to render a given geospatial asset, various types of data may be available for presentation to the user. For example, 2-D map data is often used to present detailed high density information, such as road labels, road vectors, business information and/or the like. Similarly, 3-D map data is often used to present detailed contextual information about a geographic area, such as a by providing an overview of a city or other geographic area.

Many conventional GIS clients are only equipped to provide 2-D and 3-D map data as separate user experiences. Specifically, such GIS client typically provide for a “mode switch,” which may allow the user to switch between a 2-D map mode and a 3-D map mode. Other conventional GIS clients provide for a “hybrid mode” within which 2-D map data is overlaid onto a 3-D map across the entire map view presented to the user. However, with such a “hybrid mode,” it is often difficult to discern between the overlaid 2-D and 3-D map data, thereby making it challenging and/or frustrating for the user to gather useful information from the map view presented on his/her device. As a result, conventional GIS clients currently provide for a less than optimal user experience.

### SUMMARY

Aspects and advantages of embodiments of the invention will be set forth in part in the following description, or may be obvious from the description, or may be learned through practice of the embodiments.

In one aspect, the present subject matter is directed to a computer-implemented method for providing combined multi-dimensional map views. The method may generally include receiving, by one or more computing devices, a first set of geospatial data associated with rendering a two-dimensional view of a first portion of a geographic area, receiving, by the computing device(s), a second set of geospatial data associated with rendering a three-dimensional view of a second portion of the geographic area and rendering, by the computing devices(s) a combined map view of the geographic area based on the first and second sets of geospatial data. The combined map view may include a first discrete map area providing a two-dimensional map view of the first portion of the geographic area and a second discrete map area providing a three-dimensional map view of the second portion of the geographic area.

In another aspect, the present subject matter is directed to a system for providing combined multi-dimensional map views. The system may generally include one or more computing devices including one or more processors and associated memory. The memory may store instructions that, when executed by the processor(s), configure the computing device(s) to receive a first set of geospatial data associated with rendering a two-dimensional view of a first portion of a geographic area, receive a second set of geospatial data associated with rendering a three-dimensional view of a second portion of the geographic area and render a combined map view of the geographic area based on the first and second sets of geospatial data. The combined map view may include a first discrete map area providing a two-dimensional map view of the first portion of the geographic area and a second discrete map area providing a three-dimensional map view of the second portion of the geographic area.

In a further aspect, the present subject matter is directed to a tangible, non-transitory computer-readable medium storing computer-executable instructions that, when executed by one or more processors, cause the processor(s) to perform specific operations. The operations may generally include receiving a request for geospatial data associated with rendering a combined map view of a geographic area, transmitting a first set of geospatial data associated with rendering a two-dimensional view of a first portion of the geographic area and transmitting a second set of geospatial data associated with rendering a three-dimensional view of a second portion of the geographic area. The first and second sets of geospatial data may provide for the combined map view to be rendered so as to include a first discrete map area providing a two-dimensional map view of the first portion of the geographic area and a second discrete map area providing a three-dimensional map view of the second portion of the geographic area.

Other exemplary aspects of the present disclosure are directed to other methods, systems, apparatus, non-transitory computer-readable media, user interfaces and devices for providing combined multi-dimensional map views within a GIS.

These and other features, aspects and advantages of the various embodiments will become better understood with reference to the following description and appended claims. The accompanying drawings, which are incorporated in and constitute a part of this specification, illustrate embodiments of the invention and, together with the description, serve to explain the related principles.

### BRIEF DESCRIPTION OF THE DRAWINGS

Detailed discussion of embodiments directed to one of ordinary skill in the art, are set forth in the specification, which makes reference to the appended figures, in which:

FIG. 1 illustrates an example view of a combined multi-dimensional map view of a geographic area in accordance with aspects of the present subject matter;

FIG. 2 illustrates another example view of a combined multi-dimensional map view of the geographic area shown in FIG. 1;

FIG. 3 illustrates a schematic view of one embodiment of a system for providing a combined multi-dimensional map view in accordance with aspects of the present subject matter;

FIG. 4 illustrates a flow diagram of one embodiment of a method for providing a combined multi-dimensional map view in accordance with aspects of the present subject matter;

FIG. 5 illustrates a schematic view of one example of a combined multi-dimensional map view in accordance with aspects of the present subject matter, particularly illustrating a first discrete map area rendered as a 3-D map view and a second discrete map area rendered as a 2-D map view, with the interface between first and second discrete map areas being shown using a lens-type display effect;

FIG. 6 illustrates a schematic view of another example of a combined multi-dimensional map view in accordance with aspects of the present subject matter, particularly illustrating a first discrete map area rendered as a 2-D map view and a second discrete map area rendered as a 3-D map view, with the interface between first and second discrete map areas being shown using a blended-type display effect;

FIG. 7 illustrates a schematic view of a further example of a combined multi-dimensional map view in accordance with aspects of the present subject matter, particularly illustrating a first discrete map area rendered as a 2-D map view and second and third discrete map areas rendered as 3-D map views;

FIG. 8 illustrates a schematic view of yet another example of a combined multi-dimensional map view in accordance with aspects of the present subject matter, particularly illustrating a first discrete map area rendered as a 2-D map view and a second discrete map area rendered as a 3-D map view, with the location of the second discrete map area being adjusted within the combined map view;

FIG. 9 illustrates a schematic view of a still further example of a combined multi-dimensional map view in accordance with aspects of the present subject matter, particularly illustrating a first discrete map area rendered as a 3-D map view and a second discrete map area rendered as a 2-D map view, with the size of the second discrete map area being adjusted within the combined map view; and

FIG. 10 illustrates a schematic view of another example of a combined multi-dimensional map view in accordance with aspects of the present subject matter, particularly illustrating a first discrete map area rendered as a 3-D map view and a second discrete map area rendered as a 2-D map view, with the location of the second discrete map area being selected so as to surround or encompass a suggested travel route displayed within the combined map view.

### DETAILED DESCRIPTION

Reference now will be made in detail to embodiments, one or more examples of which are illustrated in the drawings. Each example is provided by way of explanation of the embodiments, not limitation. In fact, it will be apparent to those skilled in the art that various modifications and variations can be made to the embodiments without departing from the scope or spirit of the embodiments. For instance, features illustrated or described as part of one embodiment can be used with another embodiment to yield a still further embodiment. Thus, it is intended that the present subject matter cover such modifications and variations as come within the scope of the appended claims and their equivalents.

### Overview

In general, the present subject matter is directed to systems and methods for providing combined multi-dimensional map views within a geographic information system (GIS) client or any other suitable application. Specifically, the systems and methods described herein may allow for a combined map view to be provided that includes a combination of two-dimensional (2-D) and three-dimensional (3-D) map views. As indicated above, current GIS applications either allow for an entire map view to be switched between a 2-D mode and a 3-D mode or allow for the presentation of a hybrid mode in which 2-D data is overlaid onto a 3-D map view across the entire viewing window. In contrast, the present subject matter allows for one or more discrete areas of the combined map view to be rendered as a 2-D map view while one or more other discrete areas may be rendered as a 3-D map view. Such a combined multi-dimensional map view may allow for a user to obtain detailed 2-D information about certain geographic areas within the map view while at the same time allowing the user to view 3-D contextual information about other geographic areas included within the same map view.

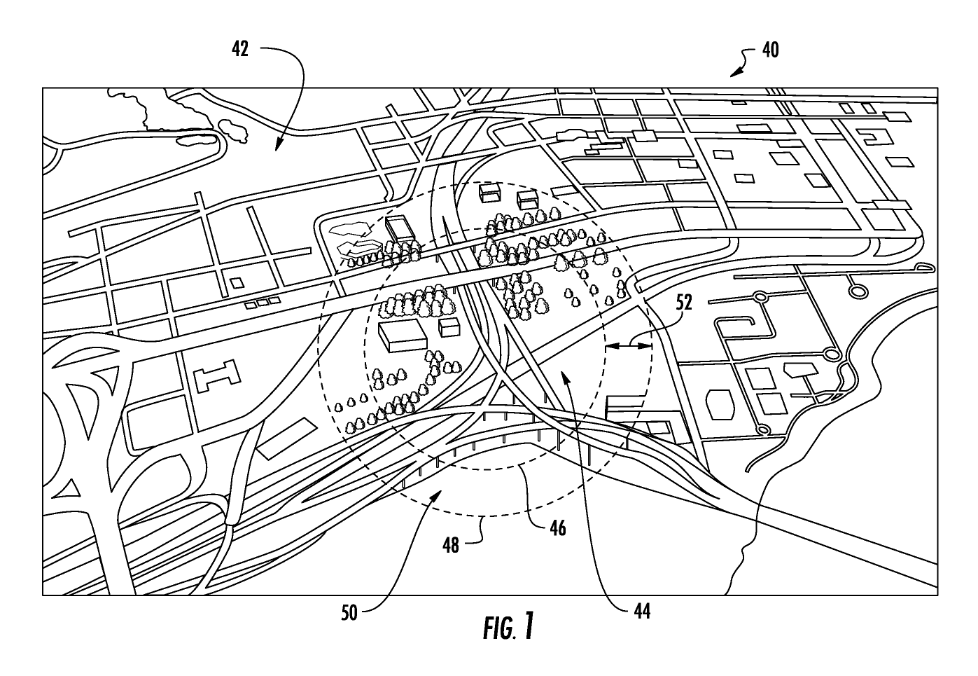

For instance, FIG. 1 illustrates an example of one embodiment of a combined multi-dimensional map view 40 displaying a given geographic area. As shown, the map view 40 includes a first map area 42 extending over a portion of the geographic area contained within the map view and a second map area 44 extending over a separate portion of the geographic area. Specifically, in the illustrated embodiment, the second map area 44 corresponds to a smaller portion of the geographic area located within the center of the map view 40 (e.g., located within an inner boundary defined by circle 46 shown in phantom lines), with the first map area 42 generally surrounding the second map area 48 (e.g., located outside an outer boundary defined by circle 48 shown in phantom lines). As shown in FIG. 1, the first map area 42 is rendered as a 2-D map view while the second map area 44 is rendered as a 3-D map view. Thus, when viewing the combined map view 40, a user may be able to view specific 2-D information associated with the first map area 42 (e.g., the road names and the orientation of the roads contained within the first map area 42) while also being able to view specific 3-D contextual information associated with the second map area 44 (e.g., the specific look of the landscape extending across the second map area 44 and/or the relative sizes of buildings and/or other structures contained within the second map area 44).

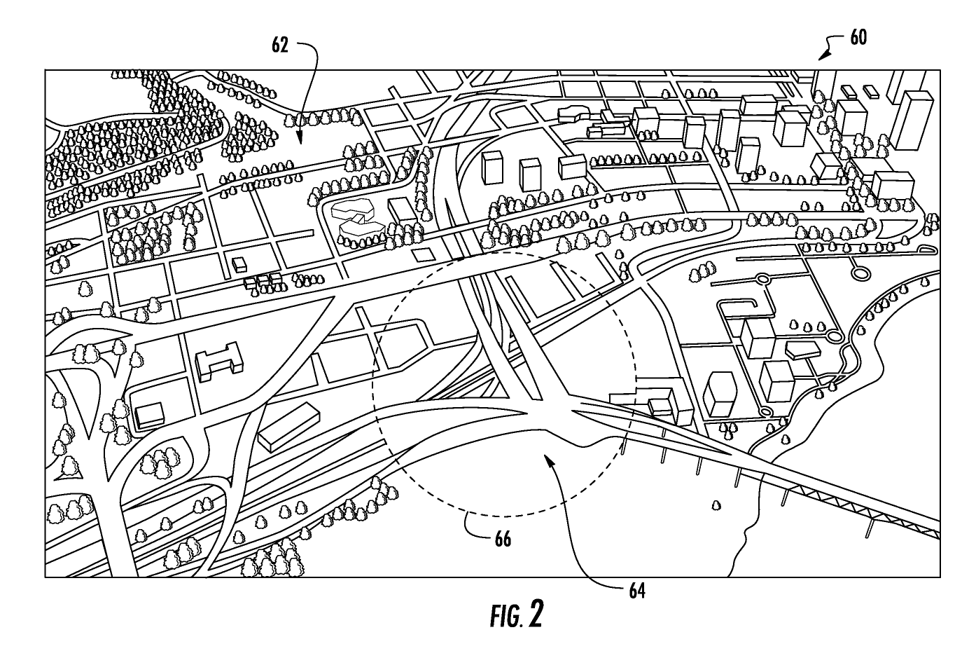

Additionally, FIG. 2 illustrates another example of a combined multi-dimensional map view 60 of the same geographic area depicted in FIG. 1. As shown, similar to the example described above, the combined map view 60 includes a first map area 62 (e.g., extending outside the boundary defined by circle 66 shown in phantom lines) and a second map area 64 surrounded by the first map area 62 (e.g., extending inside the boundary defined by circle 66). However, unlike the example shown in FIG. 1, the first map area 62 is rendered as a 3-D map view while the second map area 64 is rendered as a 2-D map view. As such, a user may be able to view 3-D contextual information associated with the larger geographic area corresponding to the first map area 62 while still being able to obtain specific 2-D information associated with the smaller, second map area 64.

By providing a means for rendering geospatial data as a combined multi-dimensional map view, numerous benefits and/or advantages may be provided to a user of a GIS client or application. For example, the portion(s) of the combined map view rendered as a 3-D map view may provide the user with spatial context for the roads and/or other 2-D information contained within the portion(s) of the combined map view rendered as a 2-D map view, thereby offering an enhanced user experience. In addition, the combined multi-dimensional view may allow for certain geographic areas to be spotlighted or highlighted within the map view being displayed to a user, thereby drawing the user's attention to such areas of the map and/or allowing for improved story-telling capability. For instance, the present subject matter may allow for points-of-interest (POIs), search results, travel routes, user-selected locations and/or any other suitable location(s)/region(s) displayed within the map view to be highlighted or otherwise differentiated by rendering such location(s)/region(s) in a different multi-dimensional view type (e.g., 2-D or 3-D) than other portions of the geographic area contained within the map view.

As will be described below, in several embodiments, a user may be allowed to define one or more map parameters associated with the combined map view, such as the multi-dimensional view type (2-D or 3-D) used to render one or more of the discrete map areas contained within the combined map view as well the shape, the size and/or location of such discrete map area(s). For example, in one embodiment, the user may simply select the shape, size and/or location of the discrete map area(s) to be rendered in a specific multi-dimensional view type (e.g., either 3-D or 2-D), with the remainder of the combined map view being rendered automatically in the other multi-dimensional view type (e.g., as the default view type). The user may also be allowed to vary the map parameters in order to adjust the data being presented. For example, the user may be able to adjust the location of one or more of the discrete map areas defined within the combined map view (e.g., by dragging the polygon defining the discrete map area(s) across the combined map view) in order to adjust which geographic region(s) within the combined map view are rendered as a given multi-dimensional view type. As such, a seamless transition between 2-D and 3-D map views may be provided as the user adjusts the location(s) of the discrete map area(s) across the combined map view.

Additionally, in several embodiments, the border or interface between the discrete map areas may be displayed using any suitable display effect, such as a blended-type display effect or a lens-type display effect. With the blended-type display effect, a transition region may be defined between the discrete map areas within which the 2-D map view fades into the 3-D map view and vice versa. For instance, as shown in FIG. 1, a transition region 50 is defined between the two map areas 42, 44 (e.g., in-between the inner and outer boundaries 46, 48) that is rendered as a blended two-dimensional and three-dimensional map view. In such an embodiment, the blended view provided within the transition region 50 may, for example, be configured to fade between a 2-D map view at the outer boundary 48 and a 3-D map view at the inner boundary 46 along a blend distance 52 defined across the transition region 50. Alternatively, with the lens-type display effect, the discrete map areas rendered as 2-D and 3-D map views may be positioned directly adjacent to one another such that a sharp transition exists at the interface between the 2-D map view and the 3-D map view. For instance, as shown in FIG. 2, the first and second map areas 62, 64 terminate along the same border (e.g., at boundary 66), thereby providing a lens or spotlight effect for the second map area 64 within the combined map view 60.

It should be appreciated that the technology described herein makes reference to computing devices, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, computer processes discussed herein may be implemented using a single computing device or multiple computing devices working in combination. Databases and applications may be implemented on a single system or distributed across multiple systems. Distributed components may operate sequentially or in parallel.

### Example Systems for Providing Combined Multi-Dimensional Map Views

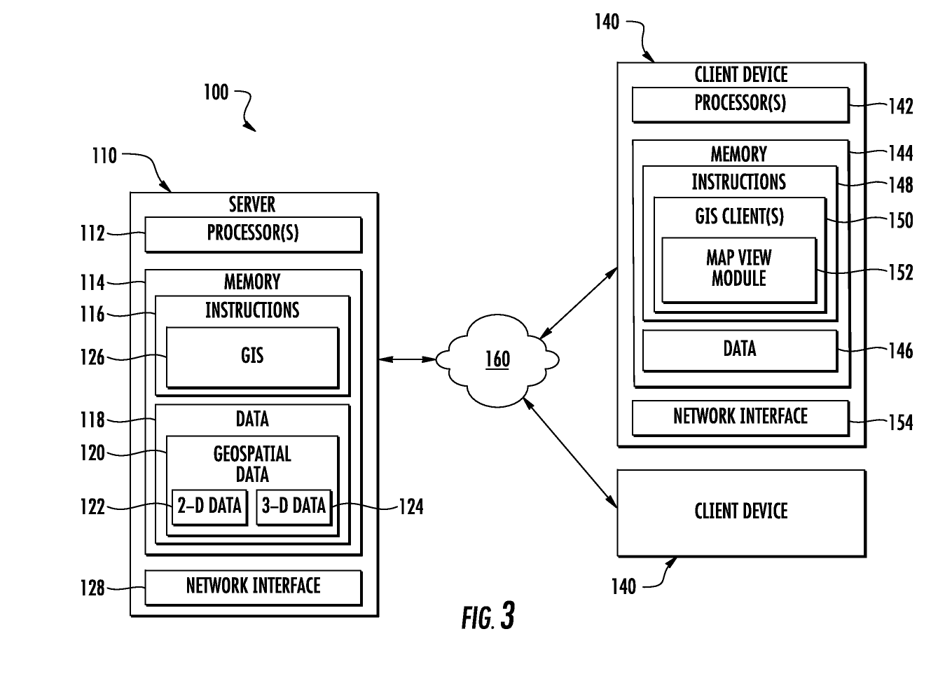

Referring now to FIG. 3, one embodiment of a system 100 for providing combined multi-dimensional map views is illustrated in accordance with aspects of the present subject matter. As shown in FIG. 3, the system 100 may include a client-server architecture where a server 110 communicates with one or more clients, such as a local client device 140, over a network 160. The server 110 may generally be any suitable computing device, such as a remote web server(s) or a local server(s), and/or any suitable combination of computing devices. For instance, the server 110 may be implemented as a parallel or distributed system in which two or more computing devices act together as single server. Similarly, the client device 140 may generally be any suitable computing device(s), such as a laptop(s), desktop(s), smartphone(s), tablet(s), mobile device(s), wearable computing device(s), a display with one or more processors coupled thereto and/or embedded therein and/or any other computing device(s). Although only two client devices 140 are shown in FIG. 3, it should be appreciated that any number of clients may be connected to the server 110 over the network 160.

In several embodiments, the server 110 may host a GIS 126, such as a mapping application (e.g. the Google Maps mapping services provided by Google Inc.), a virtual globe application (e.g. the Google Earth virtual globe application provided by Google Inc.), or any other suitable geographic information system. On the client-side, the client device 140 may present a user interface that allows a user to interact with the GIS 126. For instance, the user interface may be served through a network or web-based application that is executed on the client device 140, such as a web browser, a thin client application or any other suitable network or web-based application or the user interface may be served locally on the client device 140. The server 110 may transmit geospatial data, such as satellite and/or aerial imagery and other geospatial data (e.g., terrain and vector data), associated with rendering one or more geospatial assets (e.g., a 2-D map or 3-D globe) over the network 160 to the client device 140. Upon receipt of this data, the client device 140 may render the geospatial data, via the user interface, in the form a map view that is displayed on a display device associated with the client device 140. A user may then access and/or interact with the map view presented in the user interface. As will be described below, in several embodiments, the map view displayed to the user may correspond to a combined map view including one or more discrete map areas rendered as a 2-D map view and one or more discrete map areas rendered as a 3-D map view.

As shown in FIG. 3, the server 110 may include a processor(s) 112 and a memory 114. The processor(s) 112 may be any suitable processing device, such as a microprocessor, microcontroller, integrated circuit, or other suitable processing device. Similarly, the memory 114 may include any suitable computer-readable medium or media, including, but not limited to, non-transitory computer-readable media, RAM, ROM, hard drives, flash drives, or other memory devices. The memory 114 may store information accessible by processor(s) 112, including instructions 116 that can be executed by processor(s) 112 and data 118 that can be retrieved, manipulated, created, or stored by processor(s) 112. In several embodiments, the data 118 may be stored in one or more databases.

For instance, as shown in FIG. 3, the memory 114 may include a geospatial database 120 storing data associated with one or more geospatial assets capable of being served to the client device 140 by the server 110 (e.g., via the GIS 126). For instance, the geospatial data may correspond to any suitable data or information associated with rendering a given geospatial asset, such as imagery data (e.g., aerial and/or satellite images), vector data, terrain data, layer data, search data and/or the like. As shown in FIG. 3, such geospatial data may include both 2-D data 122 for rendering each geospatial asset as a 2-D map view and 3-D data 124 for rendering each geospatial asset as a 3-D map view. The data may also include style information specific to rendering each geospatial asset as a 2-D map view and/or 3-D map view.

Additionally, as indicated above, the server 110 may, in several embodiments, be configured to host a GIS 126 that allows the server 110 to communicate with a corresponding GIS client(s) 150 running on the client device 140. Thus, in response to access requests transmitted by the client device 140, geospatial data associated with one or more geospatial assets, including satellite and/or aerial imagery, may be transmitted to and rendered by the client device 140 to allow a user to navigate and/or interact with the geospatial asset(s).

As shown in FIG. 3, the server 110 may also include a network interface 128 for providing communications over the network 160. In general, the network interface 128 may be any device/medium that allows the server 110 to interface with the network 160.

Similar to the server 110, the client device 140 may also include one or more processors 142 and associated memory 144. The processor(s) 142 may be any suitable processing device known in the art, such as a microprocessor, microcontroller, integrated circuit, or other suitable processing device. Similarly, the memory 144 may be any suitable computer-readable medium or media, including, but not limited to, non-transitory computer-readable media, RAM, ROM, hard drives, flash drives, or other memory devices. As is generally understood, the memory 144 may be configured to store various types of information, such as data 146 that may be accessed by the processor(s) 142 and instructions 148 that may be executed by the processor(s) 142. The data 146 may generally correspond to any suitable files or other data that may be retrieved, manipulated, created, or stored by processor(s) 142. In several embodiments, the data 146 may be stored in one or more databases.

The instructions 148 stored within the memory 144 of the client device 140 may generally be any set of instructions that, when executed by the processor(s) 142, cause the processor(s) 142 to provide desired functionality. For example, the instructions 148 may be software instructions rendered in a computer readable form or the instructions may be implemented using hard-wired logic or other circuitry. In several embodiments, suitable instructions may be stored within the memory 144 for implementing one or more GIS clients 150, such as one or more earth-browsing clients and/or mapping clients, designed to render the geospatial data (including satellite and/or aerial imagery) associated with the geospatial assets available via the GIS 126. For instance, the GIS client(s) 150 may be configured to retrieve geospatial data from the server 110 and render such data in the form of a map view for display/use by the user.

As shown in FIG. 3, in several embodiments, the instructions 148 stored within the memory 144 may also be executed by the processor(s) 142 to implement a map view module 152 associated with the GIS client(s) 150. In general, the map view module 152 may be configured to retrieve 2-D and 3-D data 122, 124 associated with a given geospatial asset(s) and render such data in the form of a combined multi-dimensional map view including one or more discrete map areas rendered as a 2-D map view(s) and one or more discrete map areas rendered as a 3-D map view(s). For example, as will be described below, a user may be allowed to input one or more map parameters associated with the combined map view to be rendered for display to the user, such as the location(s), size and/or shape of the discrete map area(s) and the multi-dimensional view type for each area(s). Alternatively, such map parameters may be automatically selected based on pre-defined settings and/or any other suitable factors. Regardless, based on the map parameters to be applied, the map view module 152 may be configured to render the geospatial data provided by the server 110 in a manner that allows for the display of a combined multi-dimensional map view to the user.

It should be appreciated that the map view module 152 may be configured to render a combined multi-dimensional map view using any suitable software application and/or any other suitable computer graphics technique that allows for the 2-D and 3-D data 122, 124 to be loaded and displayed simultaneously within the combined map view. For instance, the map view module 152 may be configured to perform a blend between the 2-D data 122 and the 3-D data 124 to in order to provide a combined map view having separate map areas rendered as 2-D and 3-D map views. Such blending may be accomplished, for example, using software rasterization and/or graphic shaders (e.g., OpenGL graphic shaders).

In providing the combined map view, the map view module 152 may, in one embodiment, be configured to retrieve all of the geospatial data 120 required to render the entire geographic area being displayed as either a 2-D map view or a 3-D map view. In such an embodiment, the map view module 152 may be configured to ignore, filter out and/or overwrite the portions of such data not required for rendering the requested combined map view. Alternatively, the map view module 152 may only be configured to retrieve the specific geospatial data 120 required to render the combined map view. For example, to render the combined map view 40 shown in FIG. 1, the map view module 152 may only retrieve 2-D data 122 associated with the portion(s) of the geospatial asset extending across the first map area 42 and 3-D data 124 associated with the portion(s) of the geospatial asset extending across the second map area 44. Such a methodology may allow for the amount of data transmitted between the server 110 and the client device 140 to be minimized, which may be particularly advantageous for mobile devices that are subject to data limits.

It should be appreciated that, although the map view module 152 is shown in FIG. 3 as being implemented on the client side, the map view module 152 may, instead, be implemented by the server 110. For instance, on the server side, the map view module 152 may be configured to identify the specific geospatial data 120 required for rendering the combined map view requested by the user and transmit such data to the client device 140 for subsequent rendering and display to the user.

It should also be appreciated that, as used herein, the term “module” refers to computer logic utilized to provide desired functionality. Thus, a module may be implemented in hardware, application specific circuits, firmware and/or software controlling a general purpose processor. In one embodiment, the modules are program code files stored on the storage device, loaded into memory and executed by a processor or can be provided from computer program products, for example computer executable instructions, that are stored in a tangible computer-readable storage medium such as RAM, ROM, hard disk or optical or magnetic media.

Moreover, as shown in FIG. 3, the client device 140 may also include a network interface 154 for providing communications over the network 160. Similar to the interface 128 for the server 110, the network interface 154 may generally be any device/medium that allows the client device 140 to interface with the network 160.

It should be appreciated that the network 160 may be any type of communications network, such as a local area network (e.g. intranet), wide area network (e.g. Internet), or some combination thereof. The network can also include a direct connection between the client device 140 and the server 110. In general, communication between the server 110 and the client device 140 may be carried via a network interface using any type of wired and/or wireless connection, using a variety of communication protocols (e.g. TCP/IP, HTTP, SMTP, FTP), encodings or formats (e.g. HTML, XML), and/or protection schemes (e.g. VPN, secure HTTP, SSL).

### Example Methods for Providing Combined Multi-Dimensional Map Views

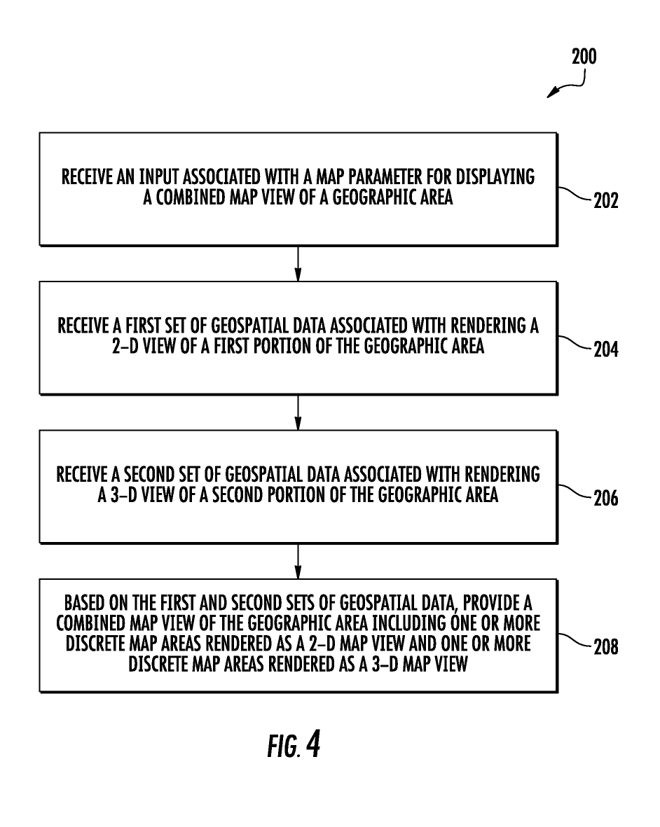

Referring now to FIG. 4, a flow diagram of one embodiment of a method 200 for providing combined multi-dimensional map views within a GIS is illustrated in accordance with aspects of the present subject matter. The method 200 will generally be discussed herein with reference to the system 100 shown in FIG. 3. However, those of ordinary skill in the art, using the disclosures provided herein, should appreciate that the methods described herein may be executed by any computing device or any combination of computing devices. Additionally, it should be appreciated that, although the method blocks 202-208 are shown in FIG. 4 in a specific order, the various blocks of the disclosed method 200 may generally be performed in any suitable order that is consistent with the disclosure provided herein.

As shown in FIG. 4, at (202), the method 200 includes receiving an input associated with a map parameter for displaying a combined map view of a given geographic area. Specifically, in several embodiments, a user may be able to provide an input selecting one or more map parameters to be associated with the combined map view to be displayed to the user via the GIS client(s) implemented on his/her device. For example, in one embodiment, one of the multi-dimensional view types (e.g., either 2-D or 3-D) may be set as the default view setting for the combined map view. In such an embodiment, the user may be allowed to select the location, size and/or shape of any discrete map area(s) within the combined map view that are desired to be rendered in the other multi-dimensional view type, as well as the display effect to be applied at the border or interface between map areas rendered with differing view types. For example, referring back to FIG. 1, the user may have selected that a circular geographic area located at the center of the combined map view 40 (e.g., the second map area 44) be rendered as a 3-D map view including a blended-type display effect around its border, with the remainder of the combined map view 40 (e.g., the first map area 42) being rendered in the default view type (e.g., as 2-D map view). Similarly, referring back to FIG. 2, the user may have selected that a circular geographic area located at the center of the combined map view 60 (e.g., the second map area 64) be rendered as a 2-D map view including a lens-type display effect around its border, with the remainder of the combined map view 60 (e.g., the first map area 52) being rendered in the default view type (e.g., as 3-D map view).

It should be appreciated that, in several embodiments, the location(s) of the discrete map area(s) to be rendered in the non-default view type may be selected so as to highlight a specific geographic area within the combined map view. In doing so, as indicated above, the location(s) of such map area(s) may be manually selected by the user, such as by allowing the user to select or manipulate the location of a polygon(s) defining the map area(s) within the combined map view. For instance, if the user desires to view a specific city block as a 3-D map view, the user may be allowed to draw or create a polygon that bounds the city block within the combined map view so as to define the map area to be rendered in 3-D. Alternatively, the location of such discrete map area(s) within the combine map view may be automatically selected based on user preferences, user requests, user location, search results, pre-defined points-of-interest (POIs) and/or any other suitable factors. For instance, if a user searches for a specific location within a city (e.g., a specific building or address), a discrete map area may be automatically defined around the building/address and rendered in the non-default view type in order to highlight such location to the user. Similarly, as will be described below, if a user requests driving directions between two locations, the suggested travel route may be rendered in a different view type (e.g., as a 2-D map view) than the remainder of the combined map view to allow a user to easily identify the travel route when viewing the map. As another example, if the user is viewing a geographic area that includes one or more pre-defined POIs, such POI(s) may, in one embodiment, be automatically rendered in the non-default view type. For instance, assuming the default view type is set as a 2-D map view, the geographic area(s) including and immediately surrounding any pre-defined POIs contained within the combined map view, such as parks, monuments, buildings and/or other landmarks, may be automatically rendered as 3-D map views to differentiate such POI(s) from the surrounding geographic area.

At (204) and (206), the method 200 includes receiving a first set of geospatial data associated with rendering a 2-D view of a first portion of a geographic area and receiving a second set of geospatial data associated with rendered a 3-D view of a second portion of the geographic area. Specifically, as indicated above, geospatial data may be transmitted from a server (e.g., server 110 of FIG. 3) to a user device (e.g., client device 140 of FIG. 3) to allow a combined map view of a geographic area to be displayed that includes one or more discrete map areas rendered as a 2-D map view(s) and one or more discrete map areas rendered as a 3-D map view(s). In doing so, the geospatial data transmitted to the user's device may correspond to any amount and/or type of data that allows for the combined map view to be rendered. For example, the server 110 may be configured to transmit all of the 2-D and 3-data associated with rendering the entire geographic area presented within the combined map view or the server may only be configured to transmit the 2-D and 3-D data necessary to render the specific 2-D and 3-D map views that are to be presented to the user within the combined map view.

Referring still to FIG. 4, at (208), the method 200 includes rendering the combined map view of the geographic area based on the first and second sets of geospatial data. Specifically, the combined map view may be rendered so as to include at least one discrete map area providing a 2-D map view of a portion(s) of the geographic area and at least one discrete map area providing a 3-D map view of a different portion(s) of the geographic area. As indicated above, such a combined map view may generally be rendered or otherwise created using any suitable software application and/or graphics technique, such as by using software rasterization and/or graphic shaders.

### Examples of Combined Multi-Dimensional Map Views

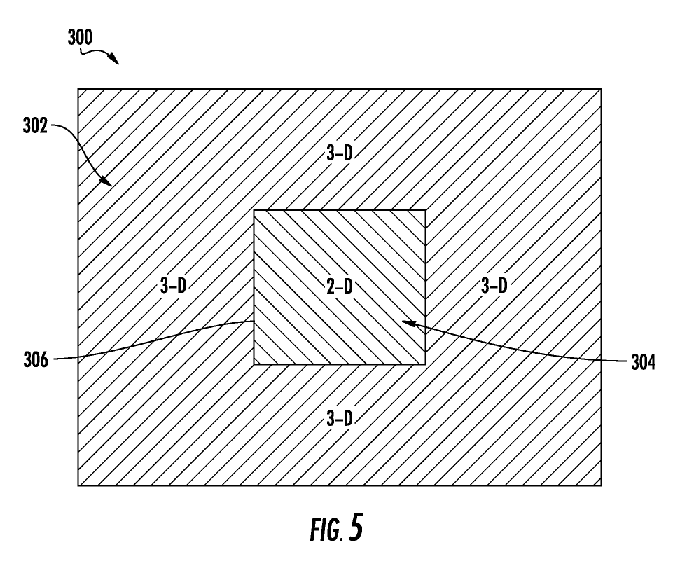

As indicated above, the combined map view provided in accordance with aspects of the present subject matter generally includes one or more map areas rendered as a 2-D map view(s) and one or more map areas rendered as a 3-D map view(s). In providing such a combined map view, the specific configuration of the 2-D map areas and/or the 3-D map areas may generally vary depending on user-defined and/or pre-defined map parameters and/or settings. For instance, FIGS. 5-10 illustrate various examples of differing configurations of combined map views that may be presented to a user of a GIS. However, one of ordinary skill in the art should appreciate that various other configurations of the disclosed combined map views may be presented to a user in a manner consistent with the disclosure provided herein.

It should also be understood that, for purposes of explanation, the examples of the combined map views shown in FIGS. 5-10 will generally be described within reference to a first map area rendered in a first, default view type (e.g., 2-D or 3-D) and one or more other discrete map areas rendered in a second, non-default view type (e.g., the other of 2-D or 3-D). However, one of ordinary skill in the art should readily appreciate that the present subject matter may be implemented without using any default view settings.

Referring to FIG. 5, a schematic view of one example of a combined map view 300 is illustrated in accordance with aspects of the present subject matter. As shown, the combined map view 300 includes both a first, larger map area 302 rendered in a first multi-dimensional view type (e.g., as a 3-D map view) and a second, smaller map area 304 rendered in a second multi-dimensional view type (e.g., as a 2-D map view). In the illustrated embodiment, the second map area 304 generally encompasses a rectangular shaped portion of the geographic area presented within the combined map view 300. However, it should be appreciated that, in alternative embodiments, the polygon bounding such map area 304 may be configured to define any other suitable shape, such as a circular, a triangular or any other polygonal shape. For example, as indicated above, a user may be allowed to draw or otherwise create a polygon within the combined map view 300 in order to identify one or more of the map areas to be rendered in a specific multi-dimensional view type.

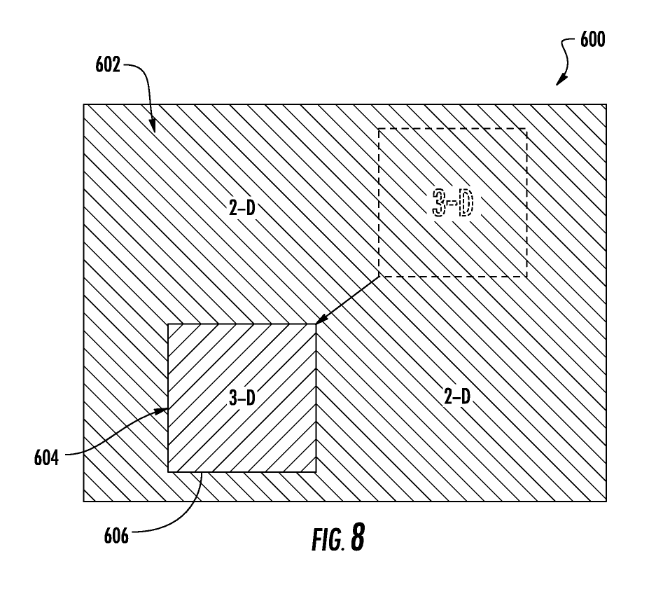

Additionally, as shown in FIG. 5, the second map area 304 is generally located within the center of the combined map view 400. However, it should be appreciated that, in alternative embodiments, the second map area 304 may be located at any suitable location within the combined map view 300, such as along one of the sides or at one of the corners. Moreover, as will be described below with reference to FIG. 8, a user may also be allowed to adjust the location of the second map area within the combined map view, thereby adjusting which portion of the geographic area contained the map view is rendered in the multi-dimensional view type associated with such map area (e.g., a 2-D map view).

FIG. 5 also illustrates a schematic view of the lens-type display effect described above with reference to FIG. 2. Specifically, as shown in FIG. 5, the first and second map areas 302, 304 extend directly up against one another so as to share a common border (e.g., the boundary defined by rectangle 306), thereby providing a sharp transition between the 2-D and 3-D map views presented to the user within the combined map view 300. Such a sharp transition generally provides a spotlight effect that can be used to highlight the second map area 304 within the combined map view 300.

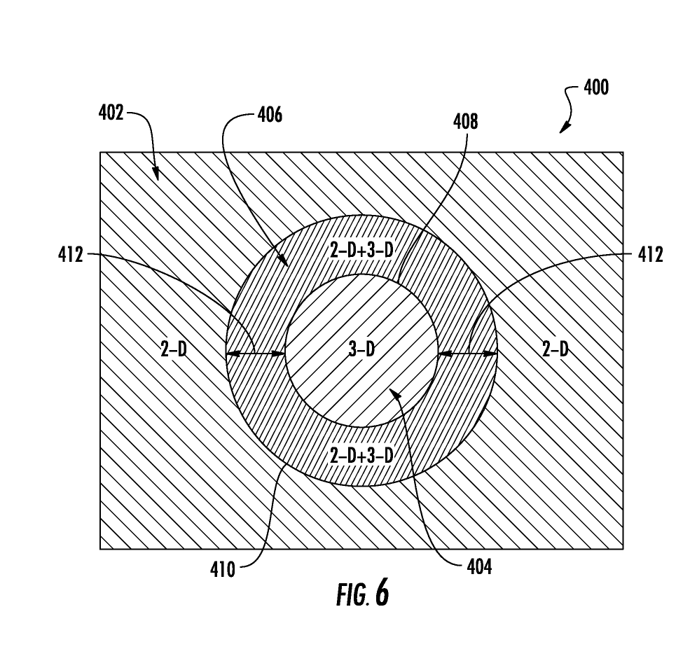

Referring now to FIG. 6, another example of a combined map view 400 is illustrated in accordance with aspects of the present subject matter. Specifically, FIG. 6 illustrates a schematic view of the blended-type display effect described above with reference to FIG. 1. As shown, the combined map view 400 includes a first map area 402 rendered in a first multi-dimensional view type (e.g., as a 2-D map view) and a second map area 404 rendered in a second multi-dimensional view type (e.g., as a 3-D map view). In addition, the combined map view 400 includes a transition region 406 defined between the first and second map areas 402, 404. Specifically, as shown in FIG. 6, the first map area 402 is defined within an inner boundary (e.g., inner circle 408) and the second map area 404 is defined outside of an outer boundary (e.g., outer circle 410) such that the transition region 406 is defined between the inner and outer boundaries 408, 410.

To provide the blended-type display effect, the geographic area included within the transition region 406 may be presented as a blend of 2-D and 3-D map views. Specifically, as shown in FIG. 6, a blend distance 412 may be defined across the transition region 406 between the inner and outer boundaries 408, 410. In such an embodiment, the multi-dimensional view type for the transition region 406 may be configured to fade from one view type to the other across the blend distance 412. For instance, a blend ratio may be defined for each location within the transition region 406 that corresponds to the percentage of 2-D data over the percentage of 3-D data that is rendered at such location. In one embodiment, the blend ratio may be varied uniformly across the blend distance 412 such that the multi-dimensional view type smoothly transitions from the specific view type associated with the first map area to the specific view type associated with the second map area as the transition region 406 extends between the inner and outer boundaries 408, 410. For instance, in the example shown in FIG. 6, it may be desirable for the multi-dimensional view type for the transition region 406 to uniformly fade from a 2-D map view at the outer boundary 410 to a 3-D map view at the inner boundary 408. In doing so, the blend ratio at the outer boundary 408 may be equal to [100/0], the blend ratio at the inner boundary 408 may be equal to [0/100] and the blend ratio at the midpoint of the blend distance 412 may be equal to [50/50].

However, in other embodiments, the blend ratio may be varied in any other suitable manner across blend distance 412 that allows for the transition region 406 to be presented as a blend of 2-D and 3-D map views. For instance, in one embodiment, the blend ratio may be varied according to a polynomial function or any other suitable mathematical expression that provides for a non-uniform variation of the blend ratio across the blend distance 412.

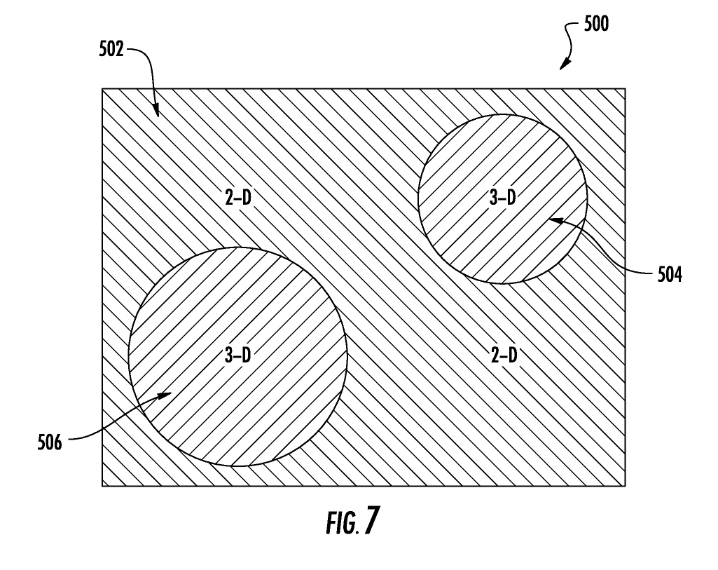

Referring now to FIG. 7, a schematic view of a further example of a combined map view 500 is illustrated in accordance with aspects of the present subject matter. As shown, the combined map view 500 includes a first map area 502 rendered in a first multi-dimensional view type (e.g., as a 2-D map view). In addition, the combined map view 500 included second and third map areas 504, 506 rendered in a second multi-dimensional view type (e.g., as a 3-D map view). In such an embodiment, the second and third map areas 504, 506 may allow for separate geographic areas presented within the combined map view 500 to be highlighted to the user. For instance, the second and third map areas 504 506 may each correspond to a geographic area bounding a predetermined POI, such as a specific landmark, park, building and/or monument, or any other suitable geographic area to be highlighted to the user. It should be appreciated that, in alternative embodiments, any other number of discrete map areas may be provided within the combined map view 500 and rendered in the non-default view type, such as by including three or more separate map areas rendered in the second multi-dimensional view type.

As indicated above, a user may be allowed to select or define one or more map parameters to be associated with the combined map view to be rendered, including the location, size and/or shape of one or more of the discrete map areas included within the combined map view. In addition, the user may also be allowed to modify such map parameters in order to adjust the look or feel of the combined map view and/or to otherwise provide for an enhanced user for experience.

For example, in several embodiments, the user may be allowed to adjust the location of one or more of the discrete map areas included within the combined map view. Specifically, as shown in FIG. 8, a combined map view 600 may include both a first, larger map area 602 rendered in a first multi-dimensional view type (e.g., as a 2-D map view) and a second, smaller map area 604 rendered in a second multi-dimensional view type (e.g., as a 3-D map view). In such an embodiment, the user may be allowed to move the polygon (e.g., the boundary polygon defined by square 606) defining the second map area 604 around the combined map view 600 in order to vary the geographic area being rendered in the second multi-dimensional view type. For instance, in the illustrated embodiment, as the associated polygon is moved across the combined map view 600 (as indicated by the dashed box and arrow), the geographic area over which the polygon is currently located may be rendered as a 3-D map view so as to provide the user 3-D contextual information associated with such area. As such, the user may be able adjust the location of the second map area 604 in order to present any portion of the geographic area provided within the combined map view 600 as a 3-D map view.

It should be appreciated that such an adjustment(s) of the location of the second map area 604 may be made in response to any suitable user input that is associated with moving the map area across the combined map view 600. For instance, in one embodiment, a user may be allowed to click on the second map area 604 and drag the associated polygon to any other location within the combined map view 600. Alternatively, the location of the second map area 604 may simply track or follow the location of the user's pointer icon (e.g., a mouse icon or the user's finger for a touch-enabled device) as it is moved across the combined map view.

In other embodiments, the location of the second map area 604 may be adjusted automatically. For instance, if the second map area 604 is configured to bound a small area encompassing the current location of the user, the location of the second map area 604 may be updated automatically as the user moves across the geographic area displayed within the combined map view 600. In another embodiment, the location of the second map area 604 may be adjusted automatically based on data animation or map touring. For example, a user may be provided with a “tour” of a given geographic area by automatically adjusting the location of the second map area 604 along a preprogrammed tour path in order to highlight specific POIs and/or other locations within the geographic area contained within the combined map view 600 as the “tour” is conducted. In such an embodiment, the combined map views disclosed herein may allow for enhanced story-telling capabilities during the course of the “tour.”

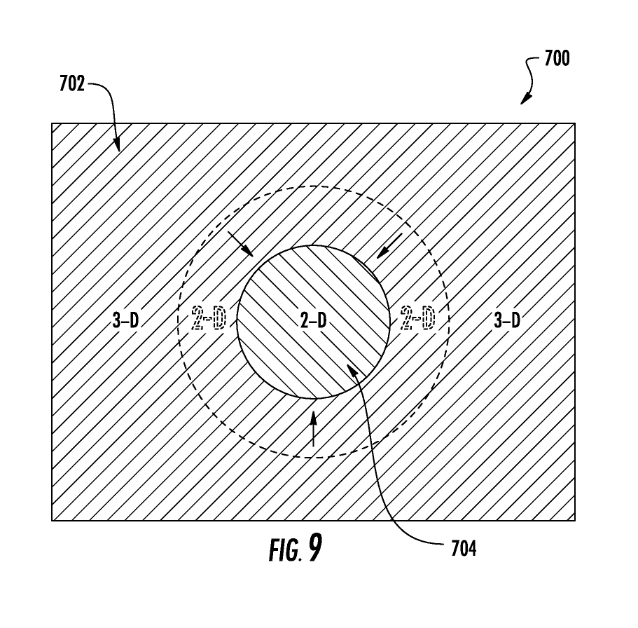

Similarly, in several embodiments, the user may also be allowed to adjust the size and/or shape of one or more of the discrete map areas presented within the combined map view. For example, as shown in FIG. 9, a combined map view 700 may include both a first map area 702 rendered in a first multi-dimensional view type (e.g., as a 3-D map view) and a second map area 704 rendered in a second multi-dimensional view type (e.g., as a 3-D map view). In such an embodiment, it may be desirable for the user to increase or reduce the size of the second map area 704 in order to adjust which portion(s) of the geographic area is rendered in the second multi-dimensional view type. For instance, in the illustrated embodiment, the second map area 704 has been reduced (as indicated by the dashed circle and arrows) to allow for an increased portion of the combined map view 700 to be presented as a 3-D map view.

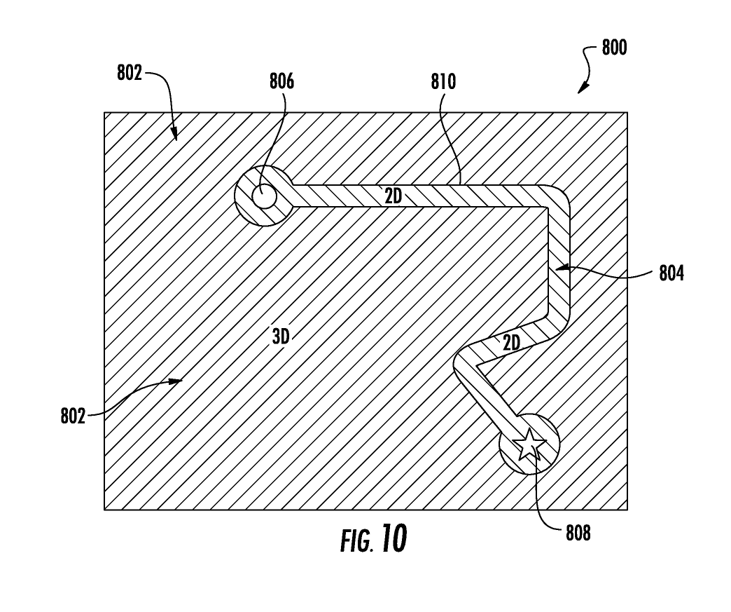

Additionally, as indicated above, the location of one or more of the discrete map areas included within the combined map view may be selected based on user-requested data. For instance, FIG. 10 illustrates a schematic view of an example of a combined map view 800 in which one of the discrete map areas is defined around a suggested travel route in response to a user request for driving directions between a first geographic location 806 and a second geographic location 808. As shown, the combined map view 800 includes a first map area 802 rendered in a first multi-dimensional view type (e.g., as a 3-D map view) and a second map area 804 rendered in a second multi-dimensional view type (e.g., as a 3-D map view), with the second map area 804 being defined by a polygon 810 extending along the suggested travel route. Specifically, the polygon 810 may be defined so that it encompasses both the first and second locations 806, 808 as well as the portion(s) of any roads included within the suggested travel route.

Such use of the combined map view may allow for travel routes to be highlighted in a manner that provides the most useful data to the user. For instance, the suggested travel route (e.g., the second map area 804) may be rendered as a 2-D map view, thereby providing the user specific 2-D information associated with the road(s) (e.g., road names, road vectors, etc.) to be traversed between the first and second locations 806, 808. In addition, by rendering the remainder of the combined map view 800 as a 3-D map, the user may be provided with specific 3-D contextual information associated with the geographic area surrounding the travel route. For instance, the 3-D map view may provide the user with contextual information associated with the buildings or other landscape located on either side of the road(s) included within the suggested travel route.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

1. A computer-implemented method for providing combined multi-dimensional map views, the method comprising:
transmitting, by one or more computing devices, a request for travel directions within a geographic area between a first geographic location and a second geographic location;
receiving, by the one or more computing devices, data associated with a suggested travel route between the first and second geographic locations;
receiving, by the one or more computing devices, a first set of geospatial data associated with rendering a two-dimensional view of a first portion of the geographic area;
receiving, by the one or more computing devices, a second set of geospatial data associated with rendering a three-dimensional view of a second portion of the geographic area; and
rendering, by the one or more computing devices, a combined multi-dimensional map view of the geographic area based at least in part on the first and second sets of geospatial data, the combined multi-dimensional map view including a first discrete map area providing a two-dimensional map view of the first portion of the geographic area and a second discrete map area providing a three-dimensional map view of the second portion of the geographic area,
wherein a boundary defined between the first discrete map area and the second discrete map area within the combined multi-dimensional map view extends along the suggested travel route,
wherein the three-dimensional view includes at least one of satellite imagery or aerial imagery of the second portion of the geographic area.

2. The computer-implemented method of claim 1, further comprising receiving an input associated with adjusting a location of the boundary within the combined multi-dimensional map view.

3. (canceled)

4. The computer-implemented method of claim 1, wherein the boundary is defined by a polygon encompassing one of the first discrete map area or the second map discrete area such that the other of the first discrete map area or the second discrete map area surrounds the polygon within the combined multi-dimensional map view.

5. (canceled)

6. (canceled)

7. (canceled)

8. The computer-implemented method of claim 1, wherein rendering the combined multi-dimensional map view comprises rendering the combined multi-dimensional map view with a transition region defined between the first discrete map area and the second discrete map area at or adjacent to the boundary.

9. The computer-implemented method of claim 8, wherein the transition region is rendered as a blended two-dimensional and three-dimensional map view.

10. (canceled)

11. (canceled)

12. The computer-implemented method of claim 1, wherein the boundary corresponds to a common border defined directly between the first and second discrete map areas within the combined multi-dimensional map view.

13. A system for providing combined multi-dimensional map views, the system comprising:
one or more computing devices including one or more processors and associated memory, the memory storing instructions that, when executed by the one or more processors, configure the one or more computing devices to:
receive a first set of geospatial data associated with rendering a two-dimensional view of a first portion of a geographic area;
receive a second set of geospatial data associated with rendering a three-dimensional view of a second portion of the geographic area;
render a combined multi-dimensional map view of the geographic area based on the first and second sets of geospatial data, the combined multi-dimensional map view including a first discrete map area providing a two-dimensional map view of the first portion of the geographic area and a second discrete map area providing a three-dimensional map view of the second portion of the geographic area; and
adjust a location of a boundary defined between the first and second discrete map areas within a two-dimensional plane of the multi-dimensional map view such that a map area associated with at least one of the first discrete map area or the second discrete map area is adjusted within the combined multi-dimensional map view,
wherein the three-dimensional view includes at least one of satellite imagery or aerial imagery of the second portion of the geographic area.

14. (canceled)

15. The system of claim 13, wherein the boundary is defined by a polygon encompassing one of the first discrete map area or the second map discrete area such that the other of the first discrete map area of the second discrete map area surrounds the polygon within the combined multi-dimensional map view.

16. (canceled)

17. The system of claim 13, wherein the one or more computing devices are configured to either render the combined multi-dimensional map view with a transition region defined between the first discrete map area and the second discrete map area at or adjacent to the boundary or render the combined map view such that the boundary corresponds to a common border defined directly between the first and second discrete map areas within the combined multi-dimensional map view.

18. A tangible, non-transitory computer-readable medium storing computer-executable instructions that, when executed by one or more processors, cause the one or more processors to perform operations, comprising:
receiving a request for travel directions within a geographic area between a first geographic location and a second geographic location;
receiving a request for geospatial data associated with rendering a combined multi-dimensional map view of the geographic area;
transmitting a first set of geospatial data associated with rendering a two-dimensional view of a first portion of the geographic area; and
transmitting a second set of geospatial data associated with rendering a three-dimensional view of a second portion of the geographic area,
wherein the first and second sets of geospatial data provide for the combined multi-dimensional map view to be rendered so as to include a first discrete map area providing a two-dimensional map view of the first portion of the geographic area and a second discrete map area providing a three-dimensional map view of the second portion of the geographic area,
wherein the first and second sets of geospatial data further provide for the combined multi-dimensional map view to be rendered so as to include a boundary defined between the first and second discrete map areas that extends within the combined multi-dimensional map view along a suggested travel route between the first and second geographic locations,
wherein the three-dimensional view includes at least one of satellite imagery or aerial imagery of the second portion of the geographic area.

19. (canceled)

20. (canceled)

21. The computer readable medium of claim 18, wherein the boundary is defined by a polygon extending across a portion of the combined multi-dimensional map view that encompasses the first and second geographic locations and any road segments provided along the suggested travel route between the first and second geographic locations.

22. The computer readable medium of claim 21, wherein the polygon is shaped such that the boundary extends adjacent to either side of the road segments provided along the suggested travel route.

23. The computer readable medium of claim 21, wherein the polygon encompasses the first discrete map area and wherein the second discrete map area extends across the combined multi-dimensional map view outside of the polygon.

24. The computer-implemented method of claim 1, wherein the boundary is defined by a polygon extending across a portion of the combined multi-dimensional map view that encompasses the first and second geographic locations and any road segments provided along the suggested travel route between the first and second geographic locations.

25. The computer-implemented method of claim 24, wherein the polygon is shaped such that the boundary extends adjacent to either side of the road segments provided along the suggested travel route.

26. The computer-implemented method of claim 24, wherein the polygon encompasses the first discrete map area and wherein the second discrete map area extends across the combined multi-dimensional map view outside of the polygon.

27. The system of claim 13, wherein the boundary is defined by a polygon encompassing one of the first discrete map area or the second discrete map area, the one or more computing devices being configured to shift a location of the polygon relative to the combined multi-dimensional map view such that the map area contained within the polygon is adjusted.

28. The system of claim 13, wherein the boundary is defined by a polygon encompassing one of the first discrete map area or the second discrete map area, the one or more computing devices being configured to adjust a size or a shape of the polygon such that the map area contained within the polygon is increased or decreased.

29. The system of claim 13, wherein the one or more computing devices are configured to adjust the location of the boundary defined between the first and second discrete map areas based on a user input associated with moving the boundary relative to the combined multi-dimensional map view.

30. The system of claim 13, wherein the boundary is defined by a polygon extending across a map area that encompasses a current location of a user of the system, the map area corresponding to one of the first discrete map area or the second discrete map area, the one or more computing devices being configured to automatically adjust the location of the boundary defined between the first and second discrete map areas based on changes in the current location of the user.

31. The system of claim 13, wherein the boundary is defined by a polygon encompassing one of the first discrete map area or the second discrete map area, the one or more computing devices being configured to automatically adjust the location of the boundary defined between the first and second discrete map areas such that a location of the polygon relative to the combined multi-dimensional map view is moved along a predetermined path across the combined multi-dimensional map view.
